(19) United States
(12) Patent Application Publication
(10) Pub. No.: US 2010/0283864 A1
(43) Pub. Date: Nov. 11, 2010

(54) IMAGE PROCESSING SYSTEM

(75) Inventors: Jun KAWAI, Kawasaki (JP); Katsutoshi Yano, Kawasaki (JP); Toshiaki Gomi, Kawasaki (JP); Hiroshi Yamada, Kawasaki (JP)

Correspondence Address: Fujitsu Patent Center;Fujitsu Management Services of America, Inc., 2318 Mill Road, Suite 1010, Alexandria, VA, 22314, US

(73) Assignee: FUJITSU LIMITED, Kawasaki-shi (JP)

(21) Appl. No.: 12/776,016

(22) Filed: May 7, 2010

(30) Foreign Application Priority Data
May 8, 2009 (JP) 2009-113930

(51) Int. Cl. H04N 5/228

(52) U.S. Cl. 348/222.1; 348/E05.031

(57) ABSTRACT

An image processing system including a plurality of image capture units and an image processing apparatus, each of image capture units including a camera taking image data, a storage unit storing use part information indicative of a use part of the image data and importance degree calculated per use part, an image clipping unit clipping segment image data serving as the use part from the image data, a transmit image data generating unit performing image processing according to the importance degree of the use part to generate transmit image data, and a transmitting unit transmitting the transmit image data, and the image processing apparatus including a network interface unit inputting a plurality of pieces of the transmit image data, an image generating unit generating the combined image data based on the plurality of pieces of transmit image data, and an display unit outputting the combined image data.

### CROSS-REFERENCE TO RELATED APPLICATIONS

This application is based upon and claims the benefit of priority of the prior Japanese Patent Application No. 2009-113930, filed on May 8, 2009, the entire contents of which are incorporated herein by reference.

### FIELD

Various embodiments described herein relate to an image processing system of taking images of surrounding parts of an object using a plurality of image capture apparatuses and synthesizing the taken images to be displayed on a display device.

### BACKGROUND

A device that supports safety driving of a driver by photographing a vehicle's surrounding parts which are in the blind angles of the driver using a plurality cameras mounted on the vehicle and displaying the parts on a display device installed in a cab is proposed. However, in the case that the resolution of each camera is increased in order to display an image of higher definition, an amount of data transmitted from the cameras to an image processing device that processes images taken using the cameras is greatly increased accordingly. Likewise, in the case that the number of cameras mounted on the vehicle concerned is increased, the amount of data transmitted from the cameras to the image processing device is greatly increased accordingly. Therefore, it sometimes occurs that the amount of data allowed to be transmitted is limited depending of a band width of a transmission path that connects each camera with the image processing device.

Japanese Laid open Patent Application Publication No. 2000-83193 and No. 10-136345 disclose techniques for reducing the amount of data transmitted from an image fetching device or a camera control device to an image receiving device. In Japanese Laid open Patent Application Publication No. 2000-83913, layout information of images to be generated is prepared on the side of the image receiving device and then is transmitted to the image fetching device. The image fetching device clips fetched image data in accordance with the acquired layout information and transmits clipped images to the image receiving device. In Japanese Laid open Patent Application Publication No. 10-136345, each camera control device detects a photographing direction and a zoom magnification of each camera and converts an image taken using each camera to an image of desired resolution and frame rate. The converted image is transmitted from the camera control device to a terminal. The terminal then synthesizes the images transmitted from respective camera control devices and displays a synthesized image on a monitor.

### SUMMARY

An image processing system includes: a plurality of image capture units mounted on a vehicle; and an image processing apparatus connected with the plurality of image capture units via a network to generate combined image data from a plurality of pieces of image data taken by the plurality of imaging capture units and to make a display unit display the combined image data, the plurality of image capture units, each includes: a camera photographing surrounding parts of the vehicle; a storage unit storing use part information indicative of a use part of the image data which is used in the combined image data, the use part information is calculated with reference to coordinate conversion data corresponding to a pattern of the combined image data, and importance degrees calculated per use part based on the resolution necessary for the each use part upon generation of the combined image data; an image clipping unit clipping segment image data serving as the use part in the combined image data from the image data taken by the camera with reference to the use part information; a transmit image data generating unit performing image processing according to the importance degree of the use part on the segment image data corresponding to the clipped use part with reference to the importance degree to generate transmit image data; and a transmitting unit transmitting the transmit image data to the image processing apparatus, and the image processing apparatus includes: a network interface unit inputting a plurality of pieces of the transmit image data transmitted from the plurality of image capture units; an image generating unit generating the combined image data based on the plurality of pieces of transmit image data; and an display unit outputting the combined image data to the display device.

The object and advantages of the invention will be realized and attained by means of the elements and combinations particularly pointed out in the claims. It is to be understood that both the foregoing general description and the following detailed description are exemplary and explanatory and are not restrictive of the invention, as claimed.

### BRIEF DESCRIPTION OF THE DRAWINGS

FIG. 1 is a diagram illustrating an example of a relation between a image capture range and a resolution of an image;

FIG. 2 is a diagram illustrating an example of a configuration of an image processing system;

FIG. 3 is a diagram illustrating an example of a general configuration of first to fourth image capture units;

FIG. 4 is a diagram illustrating examples of locations where cameras are mounted on a vehicle;

FIG. 5 is a diagram illustrating an example of transmit image conversion pattern data;

FIG. 6 is a diagram illustrating an example of segment image data clipped from image data in accordance with transmit image conversion pattern data;

FIG. 7 is a diagram illustrating an example of image data converted by a transmit image converting unit;

FIG. 8 is a diagram illustrating an example of image data converted by a transmit image converting unit;

FIG. 9 is a diagram illustrating an example of image data converted by a transmit image converting unit;

FIG. 10 is a diagram illustrating an example of a hardware configuration of a control unit of an image processing apparatus;

FIG. 11A is a diagram illustrating an example of one display on a display unit;

FIG. 11B is a diagram illustrating an example of another display on the display unit;

FIG. 12A is a diagram illustrating an example of one display on a display unit;

FIG. 12B is a diagram illustrating an example of another display on the display unit;

FIG. 13A is a diagram illustrating an example of one display on a display unit;

FIG. 13B is a diagram illustrating an example of another display on the display unit;

FIG. 14 is a flowchart illustrating procedures of generating combined image conversion pattern data and transmit image conversion pattern data by a control unit;

FIG. 15 is a flowchart illustrating procedures of generating transmit data conversion pattern data using a control unit;

FIG. 16A is a diagram illustrating a coordinate system obtained when a vehicle is viewed in a vertical direction (a Z-axis direction),

FIG. 16B is a diagram illustrating a coordinate system obtained when the vehicle is viewed in a width direction (an X-axis direction);

FIG. 17 is a diagram illustrating an example of a camera attaching angle;

FIG. 18 is a diagram illustrating an example of combined image layout pattern data;

FIG. 19A is a diagram illustrating one example of combined image conversion pattern data;

FIG. 19B is a diagram illustrating another example of the combined image conversion pattern data;

FIG. 20A is a diagram illustrating an example of one range of image data to be corrected in terms of an importance degree distribution thereof;

FIG. 20B is a diagram illustrating an example of another range of the image data to be corrected in terms of the importance degree distribution thereof;

FIG. 21A is a diagram illustrating an example of one set of importance degree distributions of image data taken using one camera;

FIG. 21B is a diagram illustrating an example of another set of importance degree distributions of image data taken using another camera;

FIG. 21C is a diagram illustrating an example of a further set of importance degree distributions of image data taken using a further camera;

FIG. 21D is a diagram illustrating an example of a still further set of importance degree distributions of image data taken using a still further camera;

FIG. 22A is a diagram illustrating an example of a state in which rectangular region have been clipped from one set of importance degree distributions of image data;

FIG. 22B is a diagram illustrating an example of a state in which rectangular regions have been clipped from another set of importance degree distributions of another piece of image data;

FIG. 22C is a diagram illustrating an example of a state in which rectangular regions have been clipped from a further set of importance degree distributions of a further piece of image data;

FIG. 22D is a diagram illustrating an example of a state in which rectangular regions have been clipped from a still further set of importance degree distributions of a still further piece of image data;

FIG. 23 is a diagram illustrating an example of transmit image conversion pattern data generated by the first to fourth image capture units;

FIG. 24 is a flowchart illustrating procedures of processing executed by a image capture unit; and

FIG. 25 is a flowchart illustrating procedures of processing executed by an image processing apparatus.

### DESCRIPTION OF EMBODIMENTS

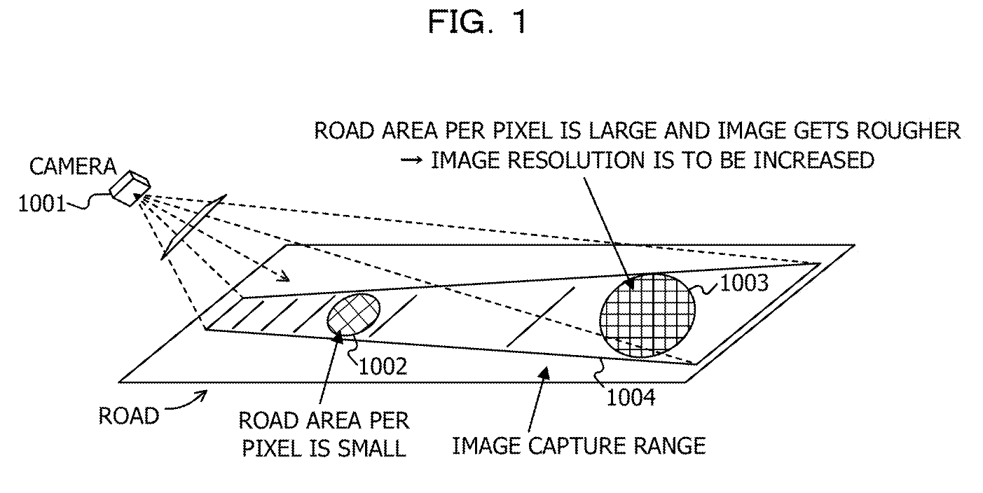

Usefulness for a driver may be increased by switching a pattern of a combined image which is generated using an image processing apparatus in accordance with each driving situation of the driver, such as right/left turning, lane change, garaging or the like. A use part of each camera image and a resolution of a required image vary as a pattern of the combined image is switched. For example, as illustrated in FIG. 1, although a ground area per pixel of an image is small on a part 1002 near a camera 1001, the ground area per pixel of the image is gradually increased as it goes away from the camera as illustrated by a part 1003. Therefore, for example, if a bird's-eye image is generated, an image of a large area will have to be generated from a small number of pixels and the image generated will gradually coarsen as a region of interest goes away from the camera within an image capture range 1004.

Accordingly, in order to generate a plurality of kinds of combined images with high definition while decreasing the amount of data transmitted from each camera to the image processing apparatus, it may be necessary to process a use part of an image to be used in a combined image so as to satisfy the resolution required for the use part and to transmit the processed part from each camera. It may be difficult to transmit whole images as they have been taken using a plurality of cameras at a processing speed attained by an existing in-vehicle LAN. Therefore, it may be desirable to decrease the amount of data to be transmitted by clipping only necessary parts from within images and transmitting the clipped parts from the cameras to the image processing apparatus.

Next, an embodiment will be described with reference to the accompanying drawings.

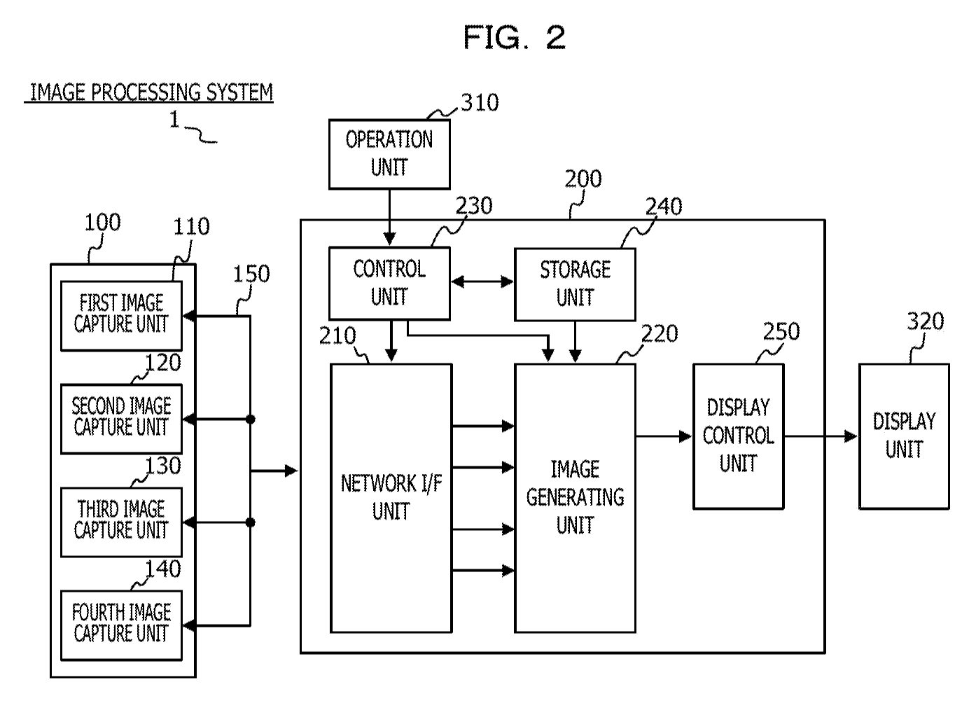

As illustrated in FIG. 2, an image processing system 1 according to an embodiment includes an imaging apparatus 100, an image processing apparatus 200, an operation unit 310 and a display unit 320. The imaging apparatus 100 has a first image capture unit 110, a second image capture unit 120, a third image capture unit 130 and a fourth image capture unit 140. Incidentally, the number of image capture units installed in the imaging apparatus 100 is not limited to four. The image processing apparatus 200 has a network interface unit (hereinafter, the interface will be abbreviated as the I/F) 210, an image generating unit 220, a control unit 230, a storage unit and a display control unit 250. The imaging apparatus 100 and the image processing apparatus 200 are connected with each other via a network 150 such as an in-vehicle LAN or the like so as to communicate with each other.

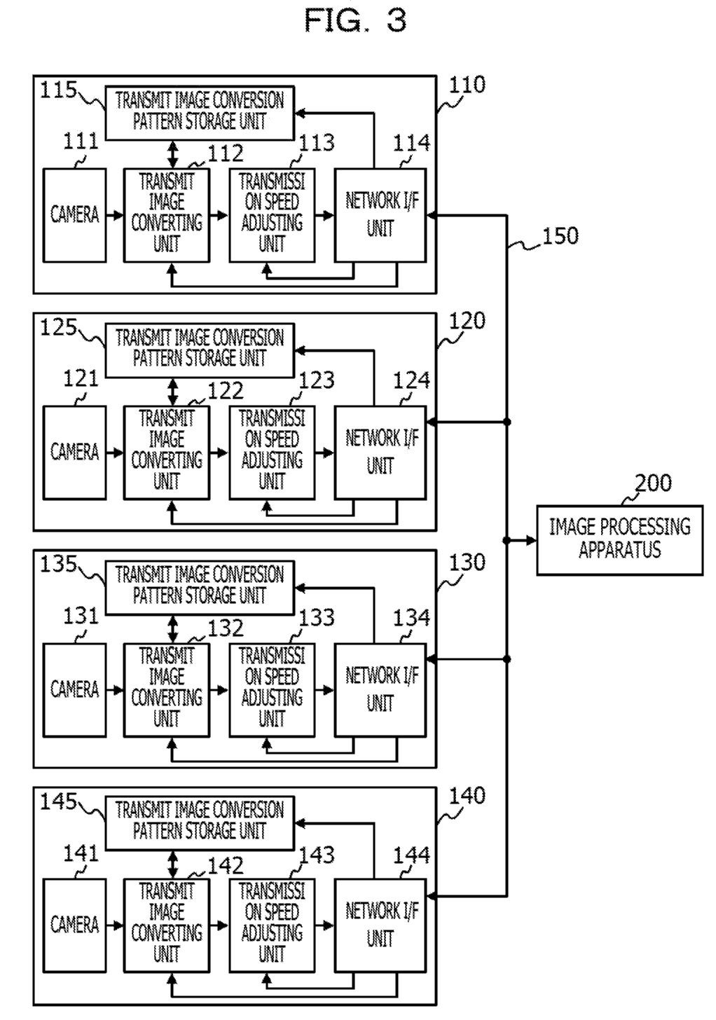

Next, details of the imaging apparatus 100 will be described with reference to FIG. 3. Incidentally, the first to fourth image capture units 110 to 140 have almost the same configuration and hence the configuration of the first image capture unit 110 will be described as a representative of the image capture units. The first image capture unit 110 has a camera 111, a transmit image converting unit 112, a transmission speed adjusting section 113, a network I/F (interface) unit 114 and a transmit image conversion pattern storage unit 115.

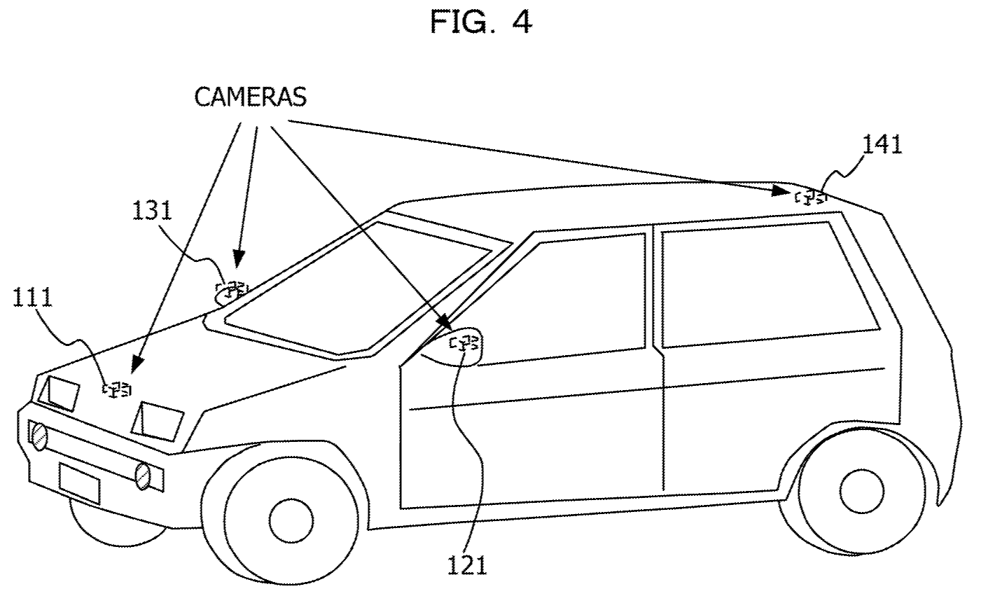

The camera 111 is an example of the image capture unit for taking images of surrounding parts of a vehicle and outputs the taken images to the transmit image converting unit 112. FIG. 4 illustrates an example of locations where the camera 111 of the first image capture unit 110, a camera 121 of the second image capture unit 120, a camera 131 of the third image capture unit 130 and a camera 141 of the fourth image capture unit 140 are installed on a vehicle. The camera 111 is disposed on a front part of the vehicle to take an image of a front part of the vehicle. The camera 121 is disposed on a left-side part of the vehicle to take an image of a left-side part of the vehicle. The cameral 131 is disposed on a right-side part of the vehicle to take an image of a right-side part. The camera 141 is disposed on a rear part of the vehicle to take an image of a rear part of the vehicle. Incidentally, although in this embodiment, four cameras are mounted on the vehicle, the number of the cameras is not limited to four and three, five or six cameras, for example, may be mounted on the vehicle. The number of cameras installed may be reduced by using a wide angle lens in each camera. Cameras may be either mounted on a vehicle upon shipment of the vehicle or disposed on a vehicle after shipment as long as the cameras are operable in cooperation with one another as an image processing system.

When a command of combined image data (a command that combined image data be generated) is given from the control unit 230 of the image processing apparatus 200, the transmit image converting unit 112 accepts the command of combined image data and acquires a transmit image conversion pattern used to generate the commanded combined image data from the transmit image conversion pattern storage unit 115. The transmit image converting unit 112 operates as an image clipping unit for clipping a used part (a part to be used in combined image data) from the image data which has been taken using the camera 111 in accordance with the acquired transmit image conversion pattern. The transmit image converting unit 112 also operates as a transmit image data generating unit for reducing the size of the clipped image data to perform image converting processing on the image data. Incidentally, the camera image data which has been subjected to image converting processing using the transmit image converting unit 112 will be referred to as segment image data. The transmit image converting unit 112 outputs the segment image data which has been subjected to image working processing to the transmission speed adjusting section 113.

The transmission speed adjusting section 113 includes a buffer (not illustrated) and temporarily stores the segment image data output from the transmit image converting unit 112 in the buffer. The transmission speed adjusting section 113 divides the segment image data acquired from the transmit image converting unit 112 into pieces of data of predetermined sizes. In addition, the transmission speed adjusting section 113 also operates as a transmitting unit that adds header information or the like addressed to the image processing apparatus 200 to the divided piece of data and transmits the data to the image processing apparatus 200 via the network I/F unit 114 as packet data. The number of pieces of packet data transmitted from each image capture unit (the first to fourth image capture units 110 to 140) of the imaging apparatus 100 via the network 150 is defined to be constant in a constant time period. Therefore, as the data size of the segment image data acquired from the transmit image converting unit 112 is decreased, the transmission speed adjusting section 113 decreases the data size of each piece of packet data accordingly. The packet data generated using the transmission speed adjusting section 113 is transmitted to the image processing apparatus 200 via the network I/F unit 114.

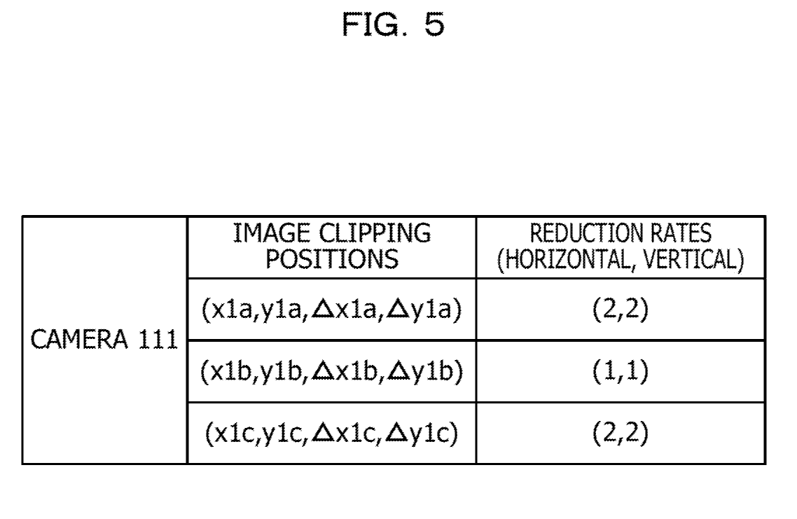

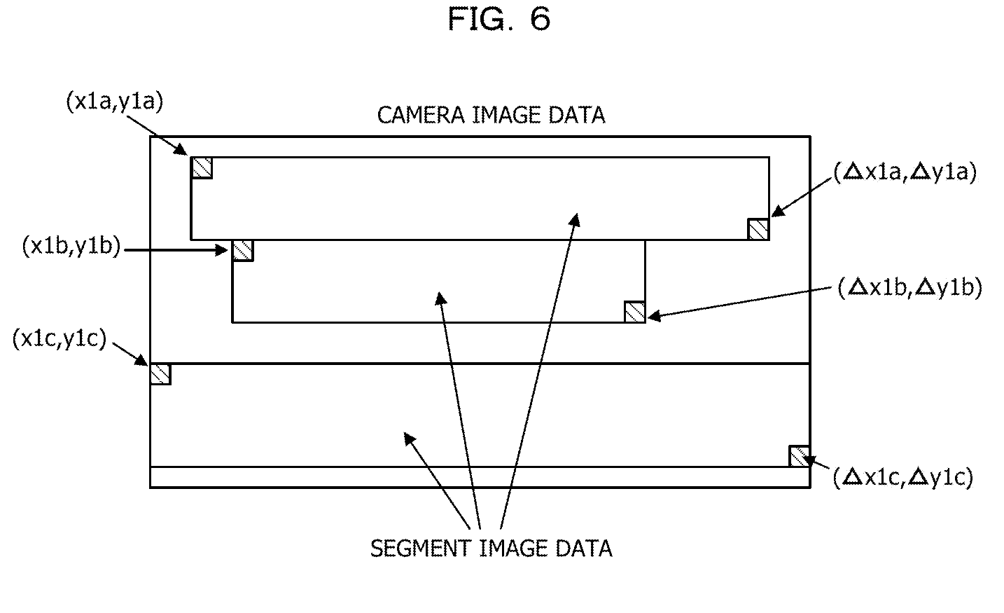

The transmit image conversion pattern storage unit 115 is a storage unit for storing transmit image conversion pattern data. RAM (Random Access Memory) and HDD (Hard Disk Drive) are examples of storage unit. FIG. 5 illustrates an example of the transmit image conversion pattern data which is stored in the transmit image conversion pattern storage unit 115 of the first image capture unit 110. The transmit image conversion pattern data includes image clipping position information indicative of a position where the image data which has been taken using the camera 111 is clipped and information for defining reduction rates at which the size of the clipped image data is reduced. The image clipping position information is indicated as positional coordinates of left upper part and right lower part of the clipped segment image data as illustrated in FIG. 6. The reduction rates include reduction rates at which the size of the image data is reduced horizontally and vertically. Incidentally, as illustrated in FIG. 6, the number of pieces of segment image data clipped from one piece of image data is not limited to one and a plurality of pieces of segment image data may be clipped from one piece of image data. The transmit image conversion pattern data is prepared by the number corresponding to the number of patterns of the combined image data generated using the image generating unit 220 and stored in the transmit image conversion pattern storage unit 115. Likewise, each of other image capture units (the second to fourth image capture units 120 to 140) stores the transmit image conversion pattern data of the number corresponding to the number of patterns of the combined image data in each of the transmit image conversion pattern storage units 125, 135 and 145. Incidentally, although in the example illustrated in FIG. 5, the image clipping position information and the reduction rates are stored as the transmit image conversion pattern data, the importance degree of each piece of data may be stored in place of the reduction rates. Details of the importance will be described later. In addition, the reduction rates are determined on the basis of the importance degree.

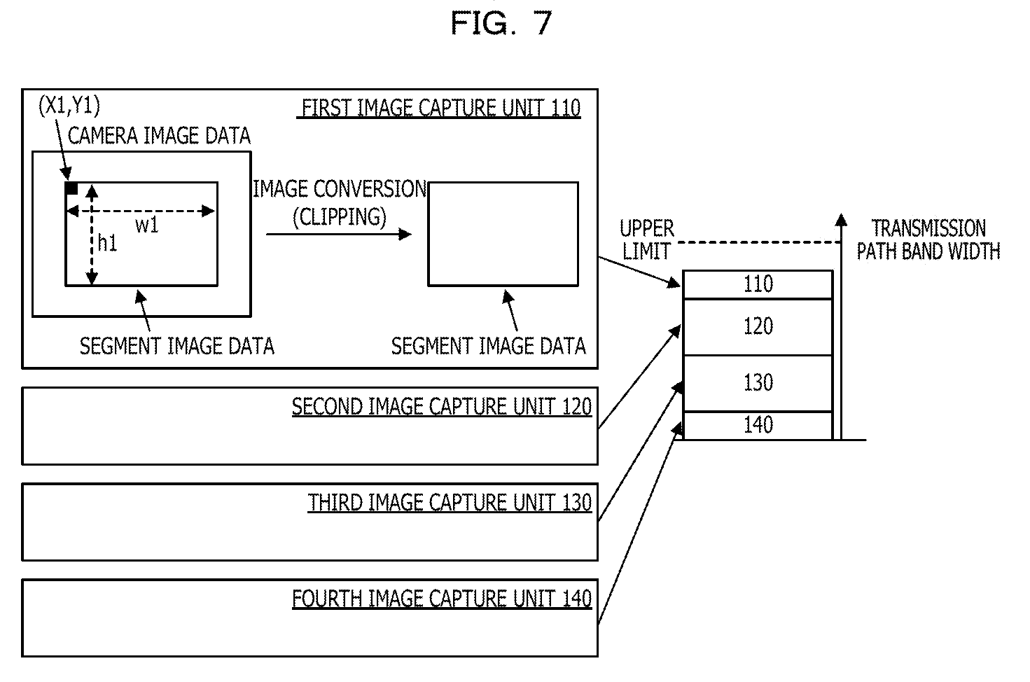

Next, processing executed using the transmit image converting unit 112 will be described in more detail with reference to FIGS. 7 to 9.

FIG. 7 illustrates an example in which after segment image data which will be a use part has been clipped from camera image data, the transmit image converting unit 112 transmits the segment image data to the image processing apparatus 200 as it is without performing a reducing process on the data. As illustrated in FIG. 7, since the segment image data including the use part is clipped from the camera image data and is transmitted to the image processing apparatus 200, the amount of data transmitted to the image processing apparatus 200 may be reduced as compared with a case in which the image data of the camera is transmitted to the image processing apparatus 200 as it is. Therefore, a data transmission speed within an upper limit value of a transmission band width of the network 150 may be attained.

In the case that images taken using the plurality of cameras 111, 121, 131 and 141 are transmitted as they are, the data amount is increased when it is intended to transmit the images of high definition, so that data transfer takes much time at the data transfer speed attained by the in-vehicle LAN. Accordingly, in this embodiment, each of the transmit image converting unit 112, 122, 132 and 142 prepares segment image data obtained by clipping a used part from the camera image data which has been taken, conforming to a resolution with which the segment image data is to be displayed. In addition, each of the transmission speed adjusting sections 113, 123, 133 and 143 allocates a band used for transmission to each piece of segment image data generated using each of the transmission speed adjusting sections 113, 123, 133 and 143 and transmits the data by adjusting the transmission speed to a speed at which data transmission is possible over the in-vehicle LAN. When the speed of transmission over the in-vehicle LAN has been increased some day, the system may be configured such that images which have been taken using the cameras 111, 121, 131 and 141 are transmitted to the image processing apparatus 200 as they are, processing sections corresponding to the transmit image conversion pattern storage units 115, 125, 135 and 145 and the transmit image converting units 112, 122, 132 and 142 of the imaging apparatus 100 are installed in the image processing apparatus 200 and the transmit speed adjusting unit 113 of the imaging apparatus 100 is eliminated so as to eliminate transmission band width allocation to each image. In the latter case, execution of complicated image processing using a camera is not necessary and hence it may become possible to handle data transmission using low cost cameras.

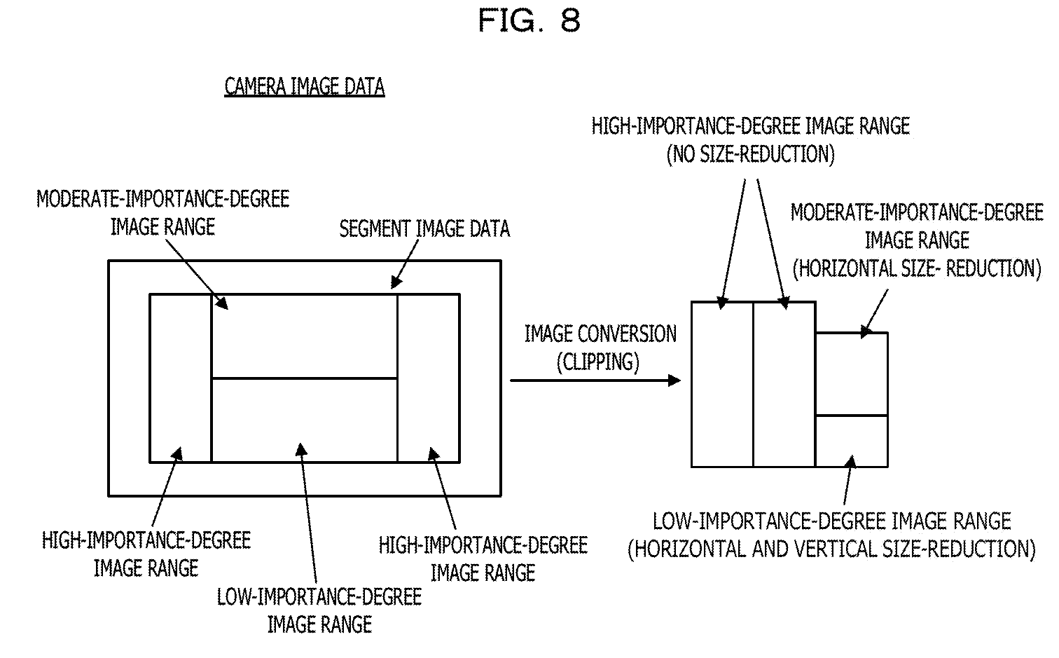

FIG. 8 illustrates as example in which after the transmit image converting unit 112 has clipped segment image data as a use part from the camera image data, it performs size-reduction processing on the segment image data and transmits the size-reduced data to the image processing apparatus 200. Incidentally, each importance degree is set to each divided region of the segment image data illustrated in FIG. 8. The importance degree is determined on the basis of the resolution attained when the image data in each of the divided regions is converted to combined image data. More specifically, the importance degree is set in accordance with scaling rates at which image data is enlarged as coordinate transformation is executed when respective pieces of image data taken using the cameras 111, 121, 131 and 141 are subjected to coordinate transformation to generate combined image data. That is, a region of a higher importance degree has a larger area which is displayed when the respective pieces of image data have been subjected to coordinate transformation to generate the combined image data. In the example illustrated in FIG. 8, the image data is divided into three regions of high, moderate and low importance degrees. However, the number of importance degrees is not limited to three and the data may be divided to a plurality of regions in accordance with the number of importance degrees attained.

The transmit image converting unit 112 does not perform size-reduction processing, for example, on image data in an image range which has been set to the high importance degree and transmits the image data in the image range to the image processing apparatus 200 as it is. The transmit image converting unit 112 reduces the data size of the segment image data in an image range which has been set to the moderate importance degree, for example, horizontally and transmits the reduced segment image data to the image processing apparatus 200 via the network I/F unit 114.

In addition, the transmit image converting unit 112 reduces the data size of the segment image data in an image range which has been set to the low importance degree, for example, horizontally and vertically. The transmit image converting unit 112 transmits the reduced segment image data to the image processing apparatus 200 via the network I/F unit 114. The transmit image converting unit 112 reduces the size of the segment image data in accordance with the transmit image conversion pattern data acquired from the transmit image conversion patter storage unit 115 and outputs the reduced segment image data to the transmission speed adjusting section 113.

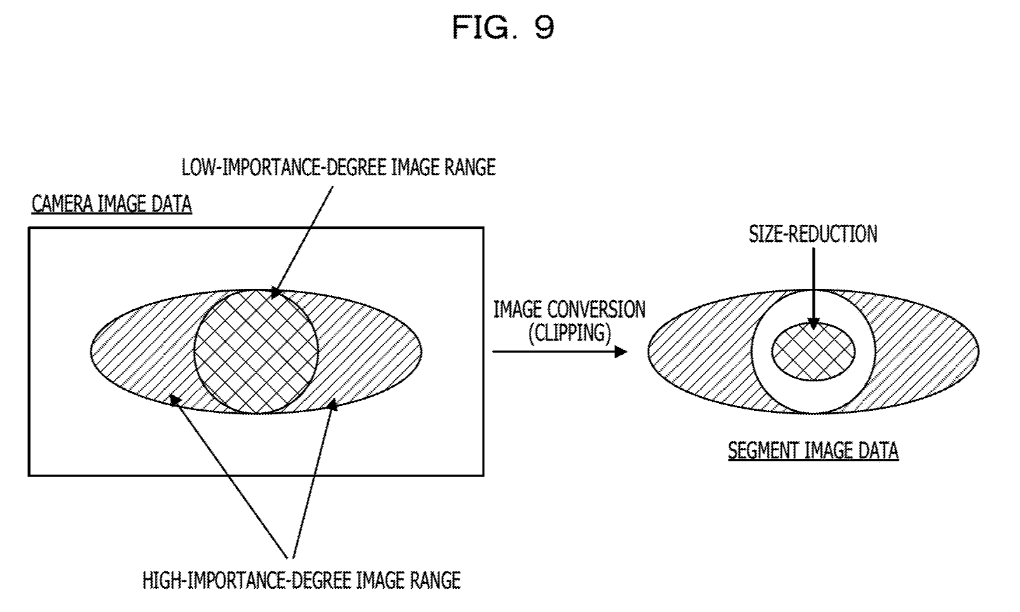

In an example illustrated in FIG. 9, the transmit image converting unit 112 does not clip segment image data from the image data in the form of a rectangular region and clips only a part which will be actually used in combined image data. In addition, the transmit image converting unit 112 performs size-reduction processing on image data in a range of low importance degree in the clipped segment image data and transmits the clipped segment image data together with the size-reduced image data. Data and processing programs necessary for image processing to be executed on the side of the camera may be mounted on the camera as a function thereof from the beginning, may be stored in the image processing apparatus in advance or may be transferred from the image processing apparatus to each camera when a vehicle has started.

Next, details of the image processing apparatus 200 illustrated in FIG. 2 will be described.

The network I/F unit 210 receives packet data transmitted from each of the first image capture unit 110 to the fourth image capture unit 140. The network I/F unit 210 converts the received packet data to the segment image data, adds blanking data to the segment image data and output the segment image data with the blanking data added to the image generating unit 220. Instead of the above mentioned operations, the NETWORK I/F UNIT 210 may operate to output the packet data which has been received from each of the first image capture unit 110 to the fourth image capture unit 140 as it is in the form of a data sequence to the image generating unit 220 without converting the received packet data to the segment image data. In the latter case, the image generating unit 220 will operate to convert the packet data in the form of the data sequence to the segment image data.

The image generating unit 220 performs coordinate transformation on the respective pieces of segment image data transmitted from the first image capture unit 110 to the fourth image capture unit 140 to generate (synthesize) combined image data in the following manner. Combined image conversion pattern data which will be described later is stored in the storage unit 240. The image generating unit 220 acquires the combined image conversion pattern data used to generate the combined image data generation of which has been commanded from the control unit 230 from the storage unit 240. The image generating unit 220 performs coordinate transformation on the respective pieces of segment image data transmitted from the first image capture unit 110 to the fourth image capture unit 140 in accordance with the acquired combined image conversion pattern data to generate the combined image data.

The display control unit 250 serves as an output unit to control to make the display unit 320 display the combined image data which has been generated by the image generating unit 220.

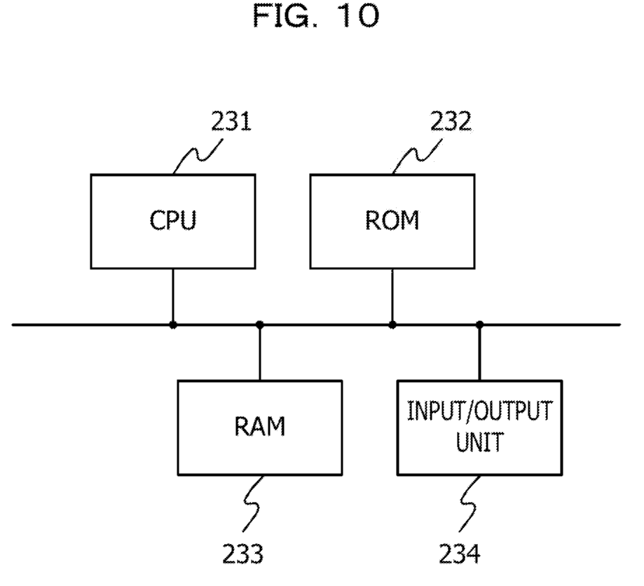

Next, details of the control unit 230 will be described. FIG. 10 illustrates an example of a hardware configuration of the control unit 230. The control unit 230 includes a CPU (Central Processing Unit) 231, a ROM (Read Only Memory) 232, a RAM (Random Access Memory) 233 and an input/output unit 234 as hardware.

Programs that the CPU 23 uses for controlling operations are recorded in the ROM 232. The CPU 231 reads therein a program recorded in the ROM 232 to execute processing in accordance with the read-in program. Data that the CPU 231 uses for arithmetic operations and data indicative of results of arithmetic operations are stored in the RAM 233. The input/output unit 234 accepts input of an operation that a user has performed using the operation unit 310 and outputs it to the CPU 231. In addition, the input/output unit 234 outputs a command signal which is output from the CPU 231 to the network I/F unit 210. The network I/F unit 210 transmits the command signal output from the input/output unit 234 to the first image capture unit 110 to the fourth image capture unit 140 via the network 150. RAM 233 is one of the examples of the storage unit 240.

The control unit 230 generates a plurality of pieces of transmit image conversion pattern data which will be described later for each pattern of the generation mage data. The transmit image conversion pattern data is generated for each of the first image capture unit to the fourth image capture unit 140. The control unit 230 transmits the respective pieces of generated transmit image conversion pattern data to the imaging apparatus 100 via the network 150. Each of the first image capture unit 110 to the fourth image capture unit 140 stores the corresponding piece of transmit image conversion pattern data transmitted from the control unit 230 in each of their transmit image conversion patter storage units 115, 125, 135 and 145. For example, the first image capture unit 110 stores the transmit image conversion pattern data in the transmit image conversion pattern storage unit 115. In addition, the control unit 230 generates the combined image conversion pattern data which will be described later and stores the generated combined image conversion pattern data in the storage unit 240. A plurality of pieces of the combined image conversion pattern data are also generated for each pattern of the combined image data as in the case with the transmit image conversion pattern data.

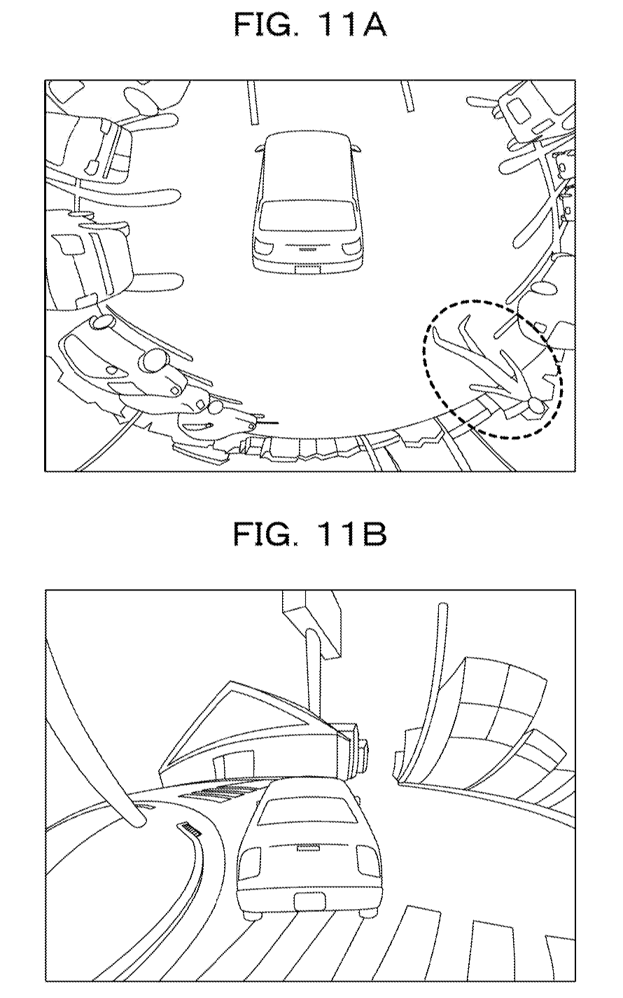

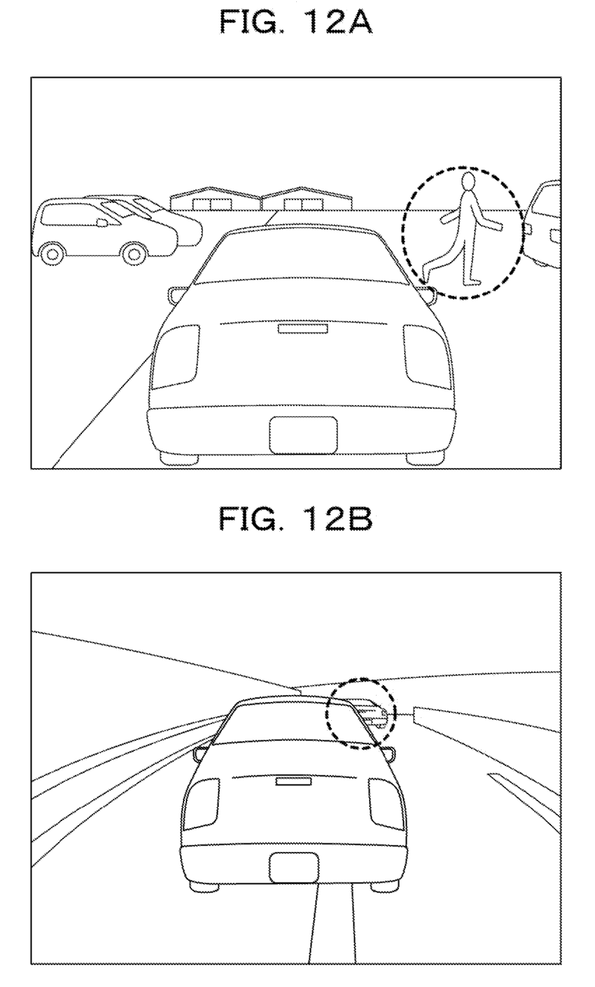

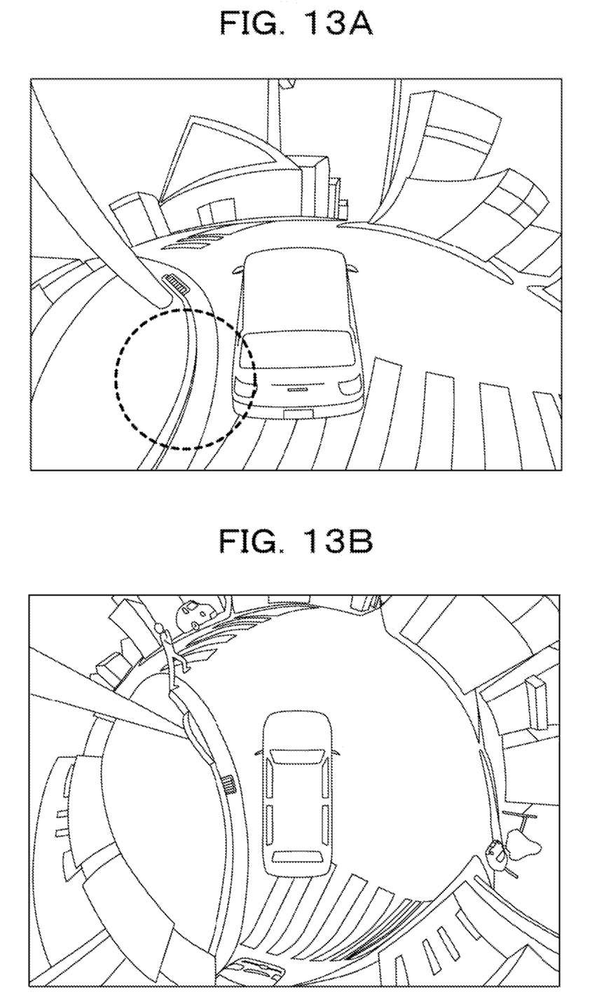

The operation unit 310 accepts input of an operation from the user. A combined image generated from the respective pieces of image data that the cameras 111 to 141 have taken is displayed on the display unit 320. The operator performs an operation to switch a pattern of the combined image to be displayed on the display unit 320 through the operation unit 310. Examples (patterns) of combined images displayed on the display unit 320 are illustrated in FIGS. 11A, 11B, 12A, 12B, 13A and 13B. Incidentally, the patterns of the combined images are not limited to the examples illustrated in the drawings and the number of the patterns may be either single or plural.

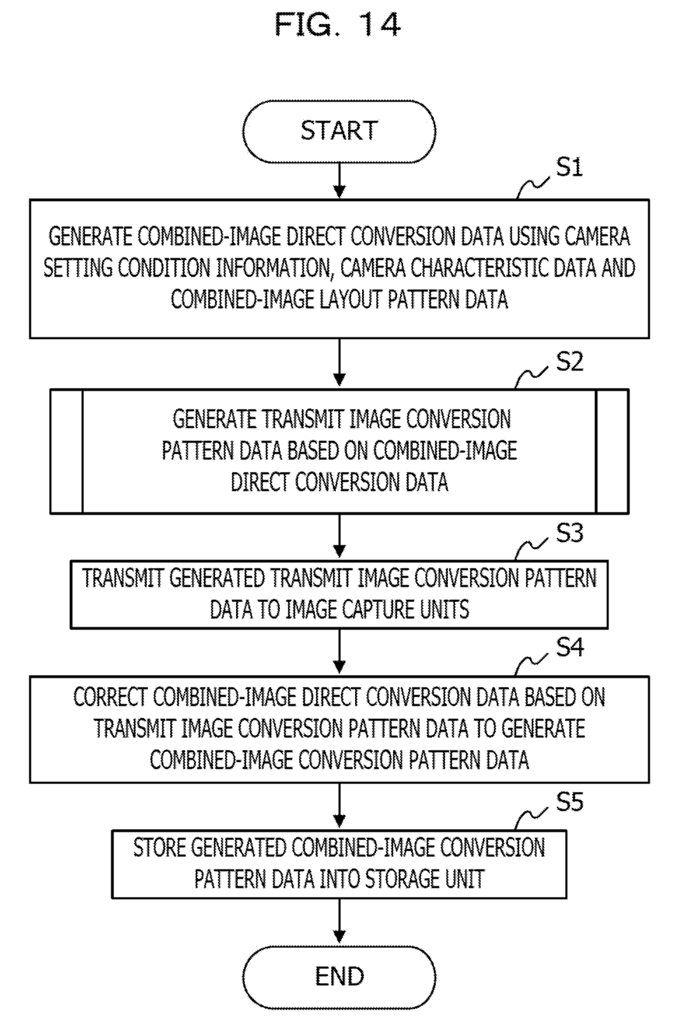

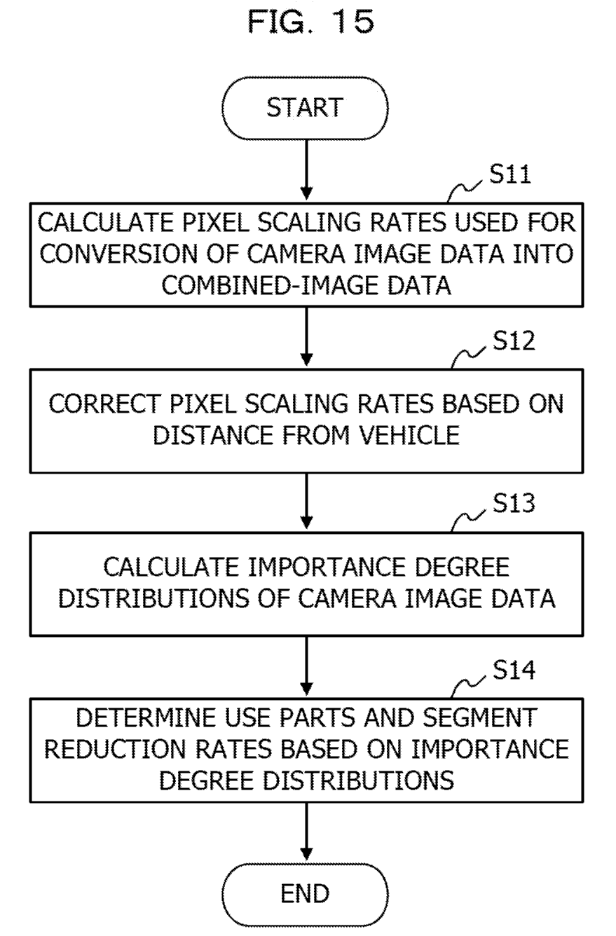

Next, procedures of generating the transmit image conversion pattern data and the combined image conversion pattern data using the control unit will be described with reference to FIGS. 14 and 15.

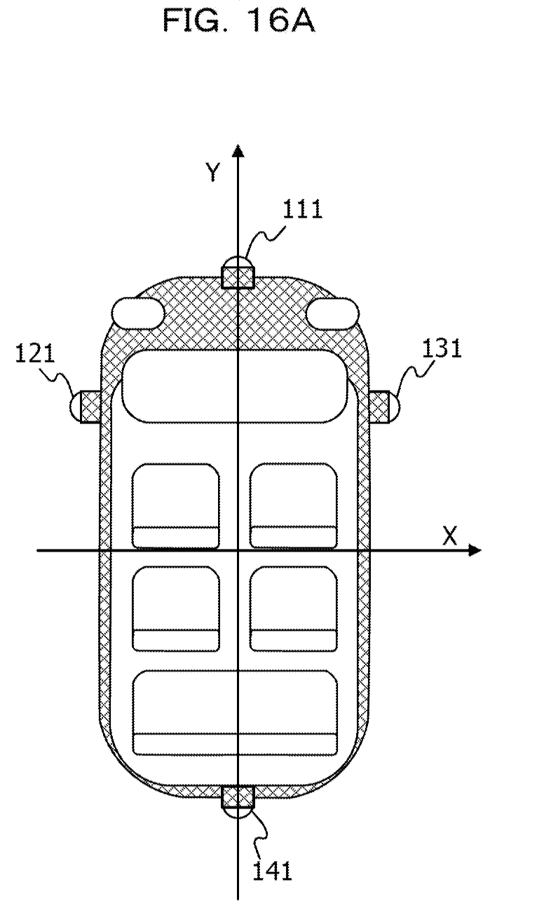

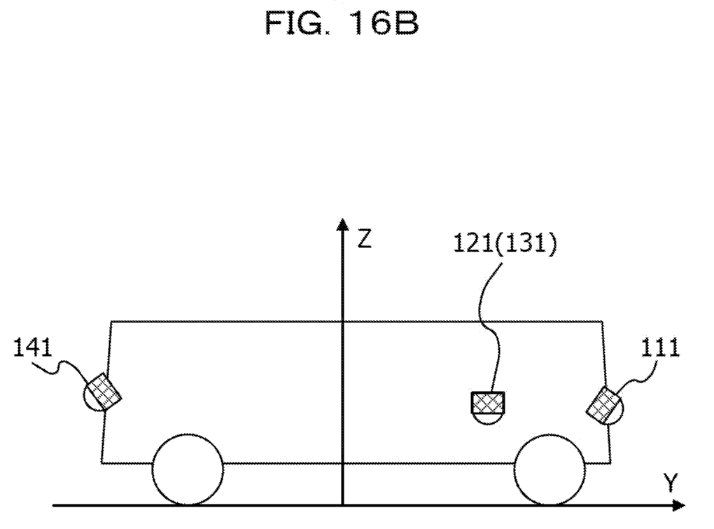

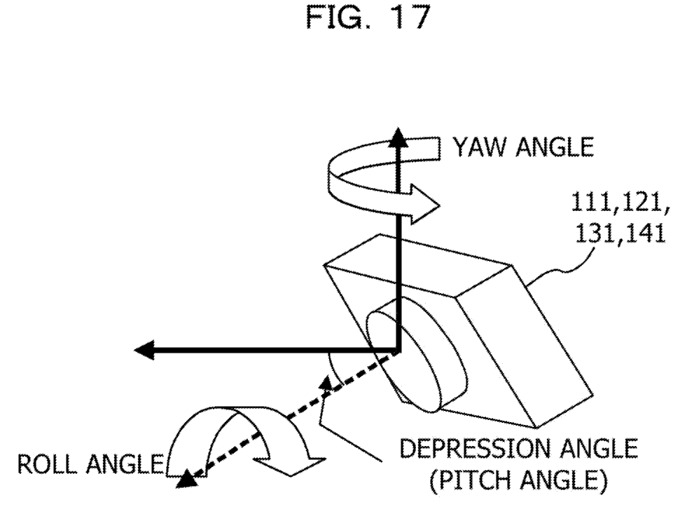

First, in preparation for operations, position coordinates and attaching angles of the respective cameras 111, 121, 131 and 141 mounted on the vehicle concerned are calculated using some means. The reason for calculation of the position coordinates and the attaching angles of the cameras per vehicle lies in that although the position coordinates and the attaching angle of each camera are fixed in advance, when the camera is actually installed, the coordinates and the attaching angle may be slightly varied and hence it is desirable to calculate the coordinates and the attaching angle after the camera concerned has been actually attached to the vehicle. An operation of calculating the position coordinates and the attaching angle of each camera is performed by an operator using equipment. As illustrated in FIGS. 16A and 16B, a width direction of the vehicle is defined as an X-axis direction, a longitudinal axis direction of the vehicle is defined as a Y-axis direction and a vertical direction of the vehicle is defined as a Z-axis direction when viewed from the center of the vehicle as an origin. FIG. 16A illustrates a coordinates system obtained when the vehicle is viewed in the vertical direction (the Z-axis direction). FIG. 16B illustrates a coordinate system obtained when the vehicle is viewed in the width direction (the X-axis direction). The camera attaching angle includes a yaw angle, a depression (pitch) angle and a roll angle. As illustrated in FIG. 17, the yaw angle is an angle of rotation on a vertical axis, the roll angle is an angle of rotation on an optical axis of a camera and the pitch angle is an angle at which the camera is vertically inclined. In the following description, the position coordinates and the attaching angle of each camera will be generally referred to as camera setting condition information. The camera setting condition information is input through the operation unit 310 and is stored in the storage unit 240 under the control of the control unit 230.

Characteristic data of the cameras 111, 121, 131 and 141 and combined image layout pattern data are included in the data stored in advance in the storage unit, in addition to the camera setting condition information. The characteristic data includes data on the number of pixels and an angle of view in each of horizontal and vertical directions and lens distortion data of each of the cameras 111, 121, 131 and 141. The angle of view is an angle of visibility of each of the cameras 111, 121, 131 and 141. The lens distortion data is data on a distorted aberration of a lens of each camera. The combined image layout pattern data includes image projection plane shape data (data on a shape of a projection plane of an image), observing point vector data and data indicative of a display range of the image. As illustrated in FIG. 18, the image projection plane shape data is shape data on the projection plane onto which a plurality of pieces of image data are projected in order to generate the combined image data from the plurality of pieces of image data taken using the respective cameras 11, 121, 131 and 141. The observing point vector data is data used to specify the image projection plane onto which image data has been projected as combined image data viewed from which direction. Display magnification of each part of an image taken using each of the cameras 111 to 141 changes in accordance with the image projection plane shape data and the observing point vector data. The data indicative of the image display range is data indicative of a range within which the image is displayed as the combined image data as illustrated in FIG. 18.

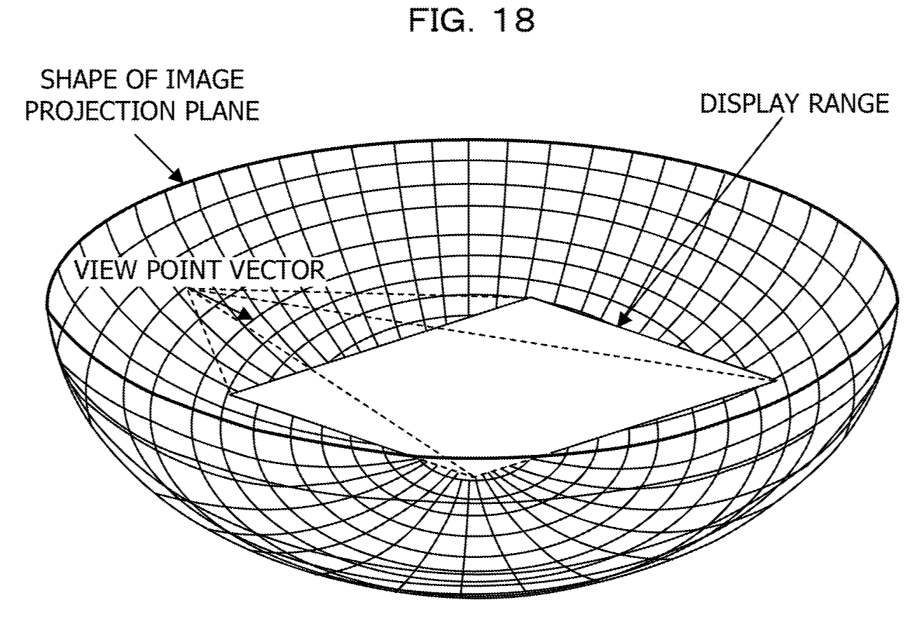

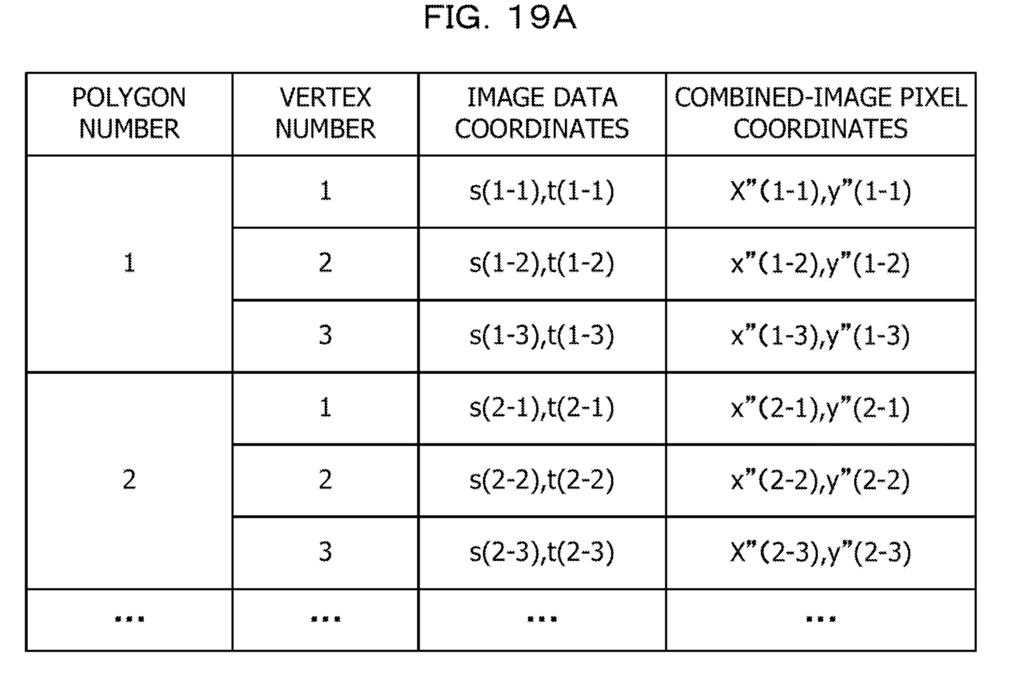

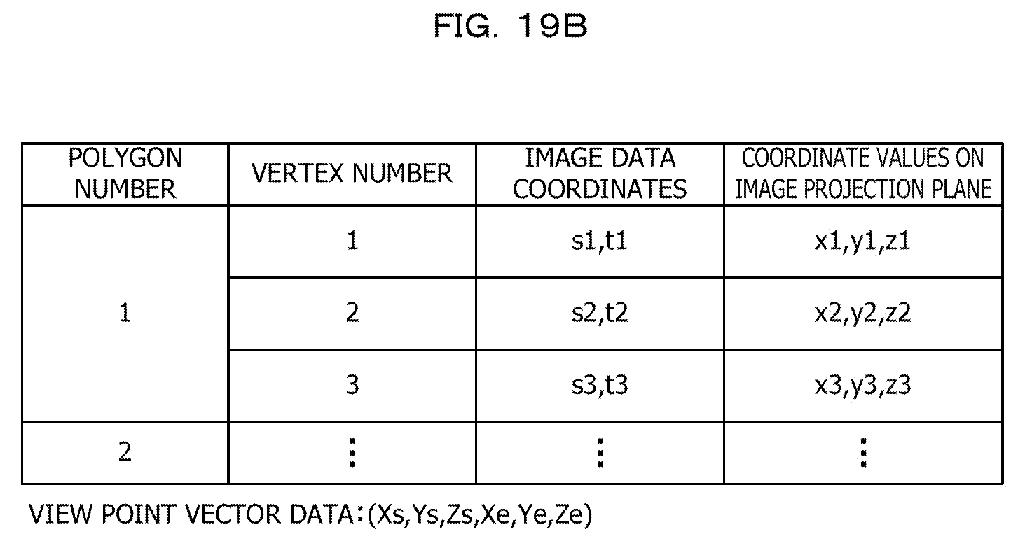

First, the control unit 230 generates combined image direct conversion data by using the camera setting condition information, the camera characteristic data and the combined image layout pattern data stored in the storage unit 240 (step S1). The combined image direct conversion data is coordinate transformation data used to convert respective pieces of image data of the cameras 111, 121, 131 and 141 to combined image data. The combined image direct conversion data includes, for example, a polygon number (a number of each polygon), a vertex number indicative of a number of each vertex of each polygon indicated by a corresponding polygon number, image data coordinates and combined image pixel coordinates as illustrated in FIG. 19A. The image data coordinates are coordinate value information obtained before the coordinates of each vertex indicated by the corresponding vertex number are transformed. The combined image pixel coordinates are coordinate value data in the combined image data obtained after the coordinates of each vertex indicated by the corresponding vertex number have been transformed. The polygon is a section as a processing unit for coordinate transformation on the basis of which the coordinates of the image data of the camera are transformed to generate the combined image data. The polygon number is an identification number for identifying each polygon. Incidentally, the combined image direct conversion data may be of a data format illustrated in FIG. 19B. The combined image direct conversion data illustrated in FIG. 19B includes the polygon number, the vertex number of the polygon indicated by the corresponding polygon number, coordinate value data in the image data obtained before the coordinates of each vertex indicated by the corresponding vertex number are transformed, data on coordinate values on an image projection plane and observing point vector data.

Next, the control unit 230 generates transmit image conversion pattern data using the combined image direction conversion data (step S2). The transmit image conversion pattern data includes data indicative of a use range which is used in the combined image data, of the image data taken using each of the cameras 111, 121, 131 and 141 and data on reduction rates at which the image data within this use range is reduced. Procedures of generating the transmit image conversion pattern data from the combined image direct conversion data will be described later with reference to a flowchart illustrated in FIG. 15.

Next, the control unit 230 transmits respective pieces of transmit image conversion pattern data so generated to the corresponding image capture units (the first image capture unit 110 to the image capture unit 140) (step S3). The first image capture unit 110 to the image capture unit 140 store the respective pieces of transmit image conversion data transmitted from the control unit 230 in their transmit image conversion pattern storage units 115, 125, 135 and 145. For example, the first image capture unit 110 stores the transmit image conversion data in the transmit image conversion pattern storage unit 115.

Next, the control unit 230 corrects the combined image direct conversion data in accordance with the transmit image conversion pattern data to generate combined image conversion pattern data (step S4). Image data transmitted from each of the first image capture unit 110 to the fourth image capture unit 140 is not image data just as it has been taken using each of the cameras 111 to 141 and image data including only a use part used in the combined image data. Thus, the control unit 230 corrects the combined image direct conversion data in accordance with the transmit image conversion pattern data in order to generate the combined image data from the segment image data including only the use part. The control unit 230 stores the combined image conversion pattern data so generated in the storage unit 240 (step S5).

Next, procedures of generating the transmit image conversion pattern data from the combined image direct conversion data using the control unit 230 at step S2 in FIG. 14 will be described with reference to a flowchart illustrated in FIG. 15.

First, the control unit 230 calculates a use range of an image used in the combined image data from the image data sent from each of the cameras 111, 121, 131 and 141 with reference to the combined image conversion pattern data. The control unit 230 calculates scaling rates obtained by executing coordinate conversion on each pixel of the image data in the use range (step 511). In the example illustrated in the drawing, the scaling rates include reduction rates and enlargement rates hereinafter, the scaling rates will be referred to as pixel scaling rates. In addition, the control unit 230 calculates a distribution of the pixel scaling rates based on the calculated pixel scaling rates of each pixel. That is, the control unit 230 calculates the pixel scaling rates at which each pixel of the image data in the use range is enlarged or reduced as coordinate conversion is executed. The pixel scaling rates may be either calculated respectively in X-axis and Y-axis directions or obtained from a ratio of an area of each pixel obtained before coordinate transformation to an area of each pixel obtained after coordinate transformation.

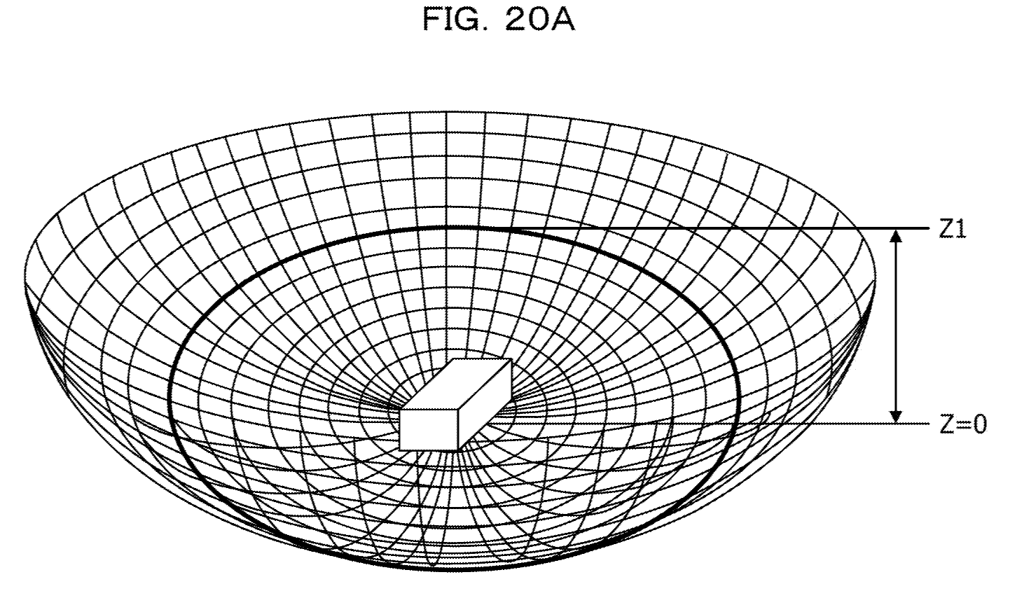

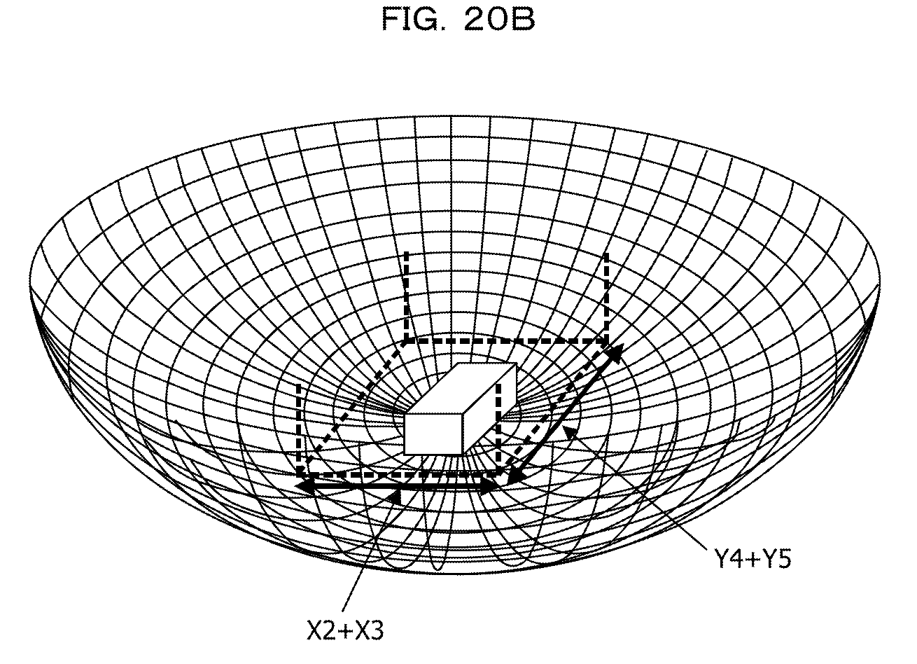

Next, the control unit 230 obtains a range in which the pixel scaling rates are corrected based on a distance from the vehicle concerned to correct the pixel scaling rates (step S12). For example, the control unit 230 judges distant and sky parts in the image data which will not be effective to support the driving to be parts unnecessary for the combined image data used to support the driving and sets the parts as out-of-object data or data to be reduced in the importance degree. In an example illustrated in FIG. 20A, a cube at the center of coordinates indicates a vehicle with the image processing system 1 mounted. The pixel scaling rate of a pixel in the combined image data whose coordinate value in the Z-axis (vertical) direction is larger than a constant value Z1 is corrected to a predetermined value or correction to reduce the pixel scaling rate by a predetermined value is performed on the pixel. In an example illustrated in FIG. 20B, only a predetermined range in the vicinity of the vehicle is judged to be an important range to support the driving in the X-axis and Y-axis directions. For example, the control unit 230 corrects the pixel scaling rates of each pixel situated on the outer side of a range of the size which is specified by X2+X3 in the X-axis direction and Y4+Y5 in the Y-axis direction as a range in which constant values are respectively added to X2 which is the total width of the vehicle and to Y4 which is the total length of the vehicle as illustrated in FIG. 20B or performs correction to reduce the pixel scaling rates of the pixel situated on the outer side of the above mentioned range by predetermined values.

Next, the control unit 230 performs processing such as clustering or normalization on the pixel scaling rates of the respective pixels which have been corrected at step S12 to classify the pixel scaling rates. The control unit 230 calculates distributions of importance degrees on the basis of the classified pixel scaling rates (step S13). For example, a distribution of pixels of the pixel scaling rates of 5 or more, a distribution of pixels of the pixel scaling rates of 2 or more and 5 or less, a distribution of pixels of the pixel scaling rates of zeros or more and 2 or less and a distribution of pixels of the pixel scaling rates of zeros in the image data are respectively obtained. Then, the distribution of the pixels of the pixel scaling rates of 5 or more is defined as a distribution of high-importance-degree pixels. The distribution of the pixels of the pixel scaling rates of 2 or more and 5 or less is defined as a distribution of moderate-importance-degree pixels. The distribution of the pixels of the pixel scaling rates of zeros or more and 2 or less is defined as a distribution of low-importance-degree pixels. A pixel of high pixel scaling rates is displayed over a large area when converted to the combined image data and hence may be judged to be high-importance-degree data. A pixel of low pixel scaling rates is displayed over a small area when converted to the combined image data and hence may be judged to be low-importance-degree data.

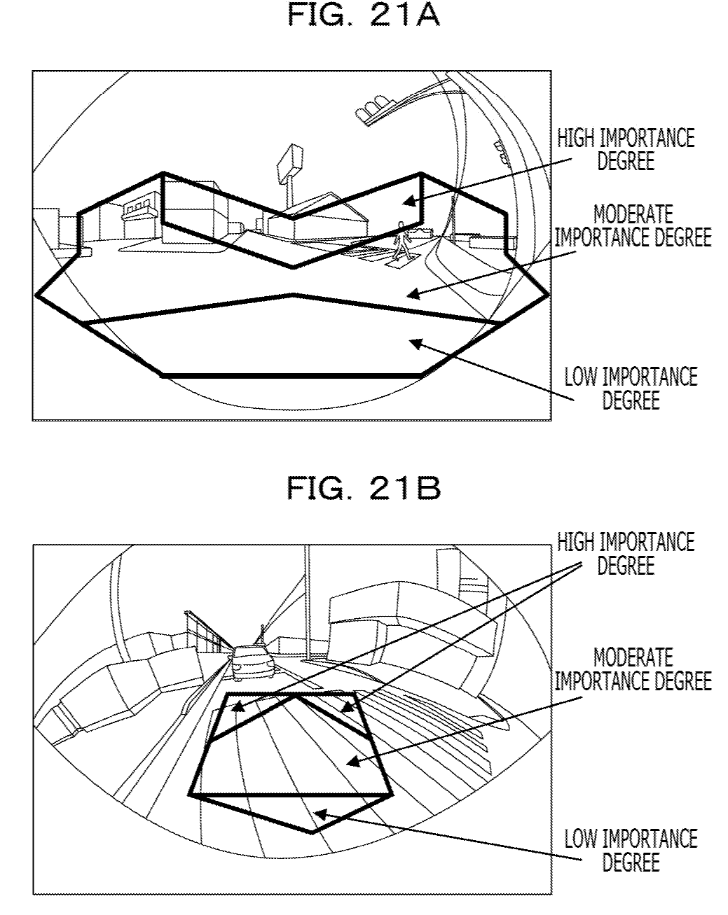

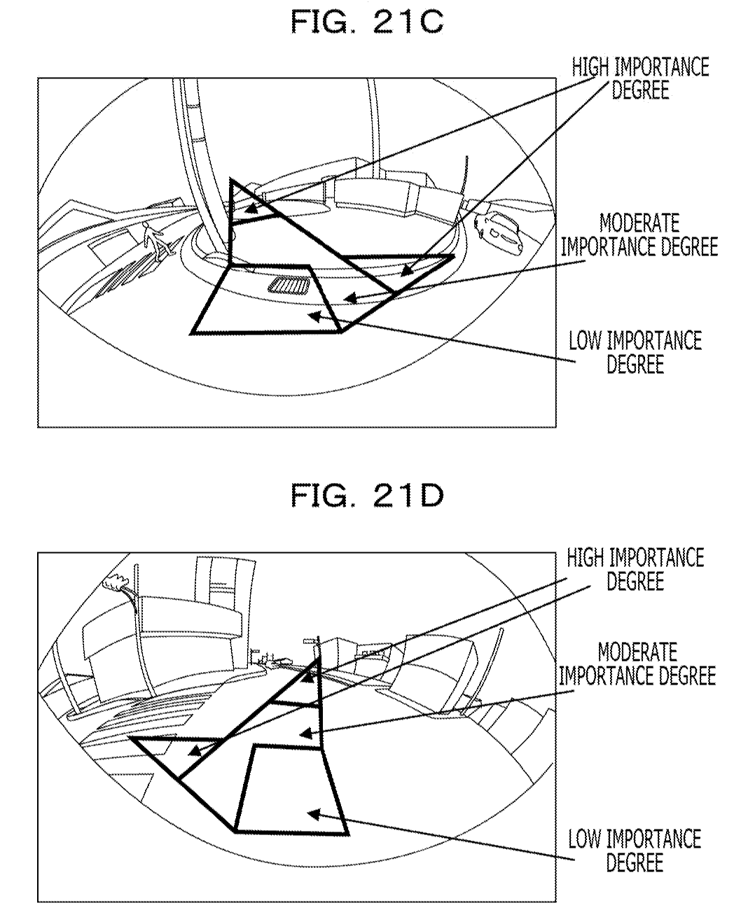

FIG. 21A illustrates a use range of vehicle front part image data which has been taken using the camera 111 and a set of distributions of respective importance degrees of the image data within the use range. Likewise, FIG. 21B illustrates a use range of vehicle left side image data which has been taken using the camera 121 and a set of distributions of respective importance degrees of the image data within the use range. FIG. 21C illustrates a use range of vehicle right side image data which has been taken using the camera 131 and a set of distributions of respective importance degrees of the image data within the use range. FIG. 21D illustrates a use range of vehicle rear part image data which has been taken using the camera 141 and a set of distributions of respective importance degrees of the image data within the use range.

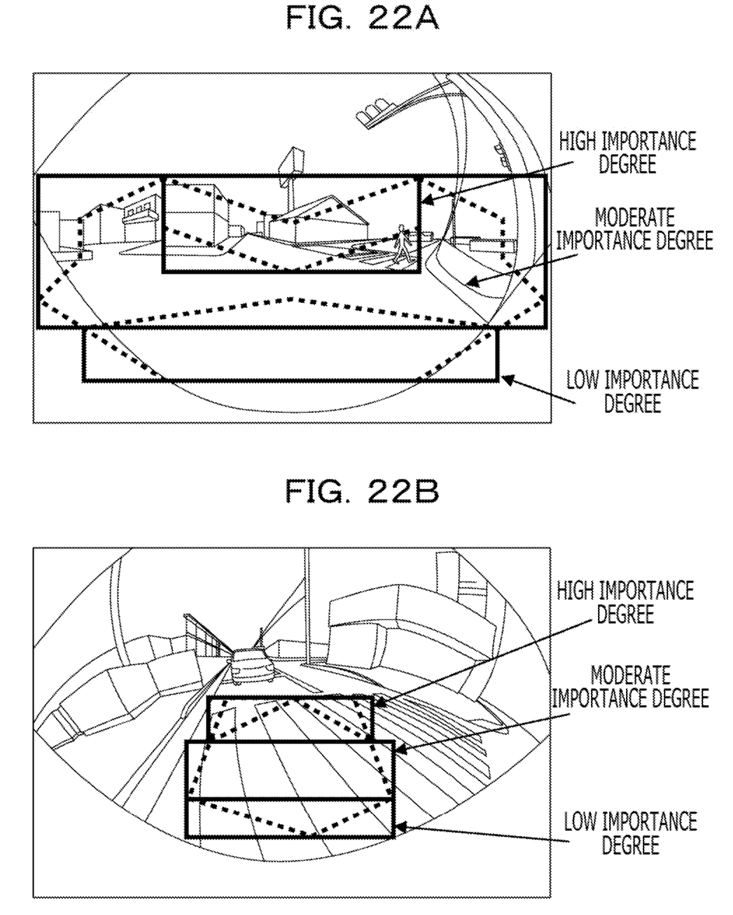

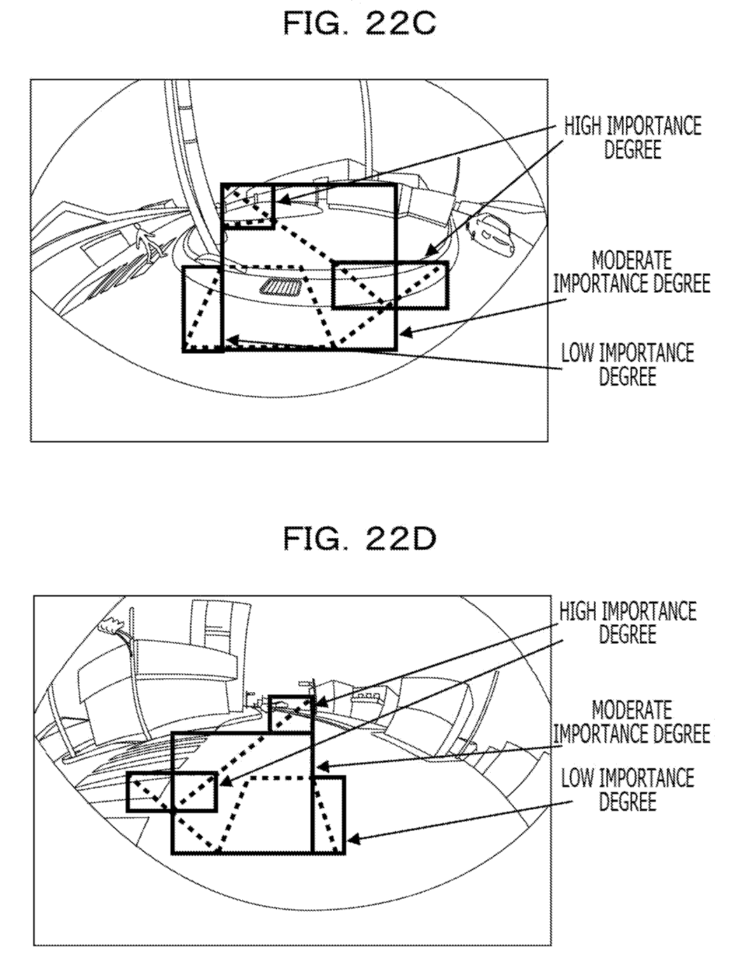

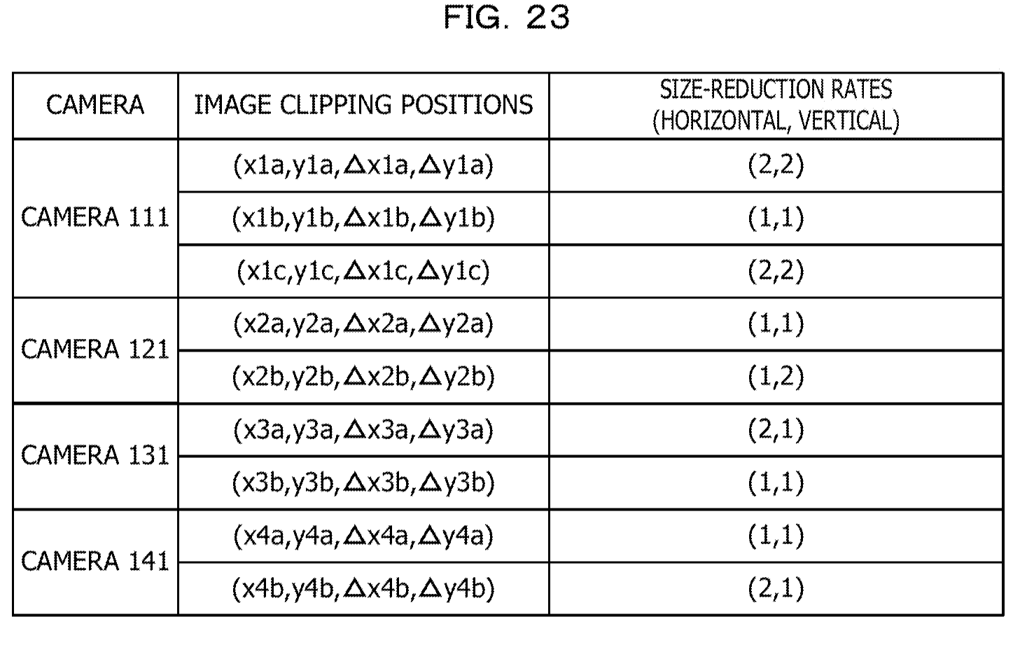

Next, at step 14, the control unit 230 clips a rectangular region including the use range on the basis of the use ranges and the importance degree distributions calculated at step S13. That is, the image data in the use range is divided into pieces depending on the respective importance degrees in the form of the importance degree distributions. The control unit 230 calculates the rectangular regions including the image data in the use range which is divided into pieces depending on the importance degrees and sets the calculated rectangular regions in a transmit range. FIG. 22A illustrates rectangular regions which have been clipped from the vehicle front part image data taken using the camera 111 and include the image data in the use ranges. Likewise, FIG. 22B illustrates rectangular regions which have been clipped from the vehicle left side image data taken using the camera 121 and include the image data in the use ranges. FIG. 22C illustrates rectangular regions which have been clipped from the vehicle right side image data taken using the camera 131 and include the image data in the use ranges. FIG. 22D illustrates rectangular regions which have been clipped from the vehicle rear part image data taken using the camera 141 and include the image data in the use ranges. Incidentally, a plurality of rectangular regions are set for one piece of image data as illustrated in FIGS. 22A to 22D. The transmit range indicates a range of the image data which is transmitted from each of the first image capture unit 110 to the fourth image capture unit 140 to the image processing apparatus 200.

In addition, the control unit 230 determines reduction rates at which the image data in the transmit range is reduced on the basis of the importance degree distributions. For example, the control unit 230 sets so as not to reduce the size of the image data in a high-importance-degree transmit range. The control unit 230 sets predetermined reduction rates for the image data in moderate-importance-degree and low-importance-degree transmit ranges. FIG. 23 illustrates an example of generated transmit image conversion pattern data of the first image capture unit 110 to the fourth image capture unit 140.

The control unit 230 executes the above mentioned processing to generate the transmit image conversion pattern data and the combined image conversion pattern data. The control unit 230 transmits each piece of transmit image conversion pattern data generated for each piece of image data of each camera to each of the first image capture unit 110 to the fourth image capture unit 140. The respective pieces of pattern-based transmit image conversion pattern data of the combined image data are stored in the transmit image conversion pattern storage units 115, 125, 135 and 145 of the first image capture unit 110 to the fourth image capture unit 140.

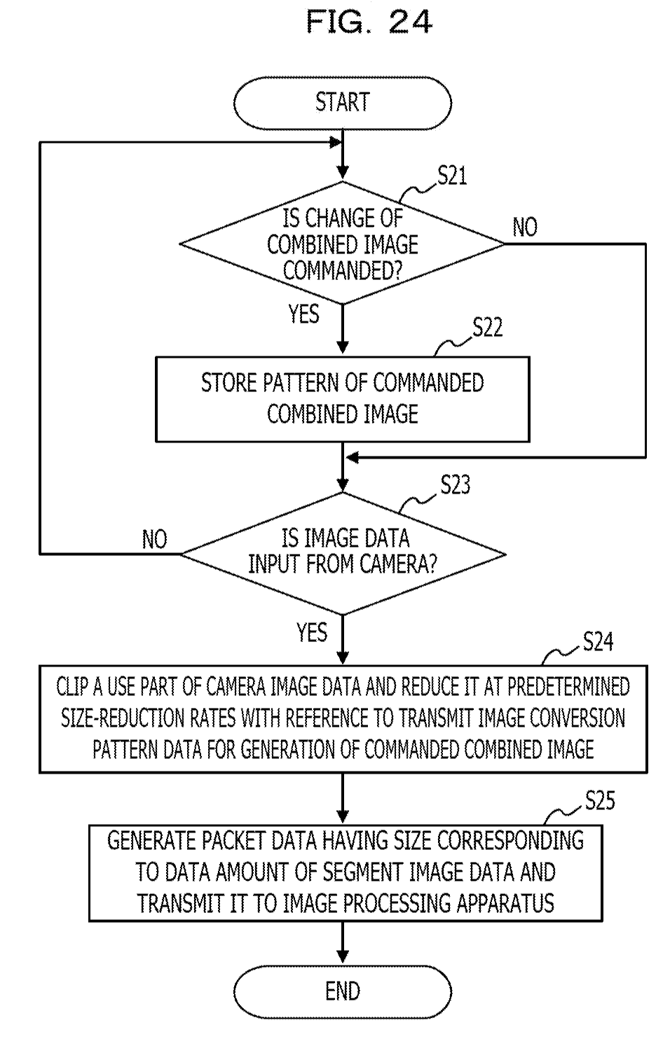

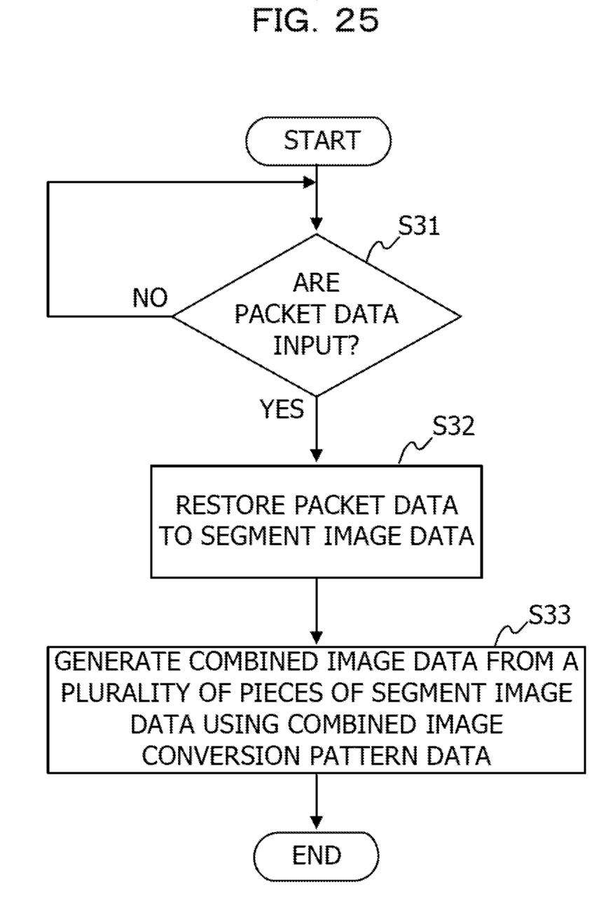

Next, procedures of operations of the image processing system 1 will be described with reference to FIGS. 24 and 25.

First, the control unit 230 judges whether a combined image change command (a command that a combined image be changed) has been input through the operation unit 310 (step S21). In the case that the combined image change command has been input (step S21/YES), the control unit 230 sends a notification that the combined image change command has been given to the imaging apparatus 100. Each of the first IMAGE CAPTURE UNIT 110 to the fourth IMAGE CAPTURE UNIT 140 which has received the notification stores the combined image change command in its memory (step S22).

Next, when an image is taken using each of the cameras 111 to 141 and image data is input (step S23/YES), each of the transmit image converting units 112 to 142 acquires transmit image conversion pattern data used to generate a combined image generation of which has been commanded from the control unit 230. Each of the transmit image converting units 112 to 142 clips image data serving as a use part from the image data taken using each of the cameras 111 to 141 and reduces the size thereof to generate segment image data with reference to the acquired transmit image conversion pattern data. For example, the transmit image converting unit 112 clips the image data serving as the use part from the image data which has been acquired using the camera 111 and reduces the size thereof to generate the segment image data (step S24). Respective pieces of segment image data which have been subjected to image working processing using the transmit image converting units 112 to 142 are respectively output to the transmission speed adjusting sections 113 to 143. For example, the segment image data generated using the transmit image converting unit 112 is output to the transmission speed adjusting section 113. The transmission speed adjusting sections 113 to 143 generate packet data of sizes corresponding to the data amounts of respective pieces of size-reduced segment image data and transmit the generated packet data to the image processing apparatus 200 (step S25).

Next, procedures of processing executed using the image processing apparatus 200 will be described with reference to FIG. 25.

The image processing apparatus 200 receives respective pieces of packet data which have been transmitted from the first image capture unit 110 to the fourth image capture unit via the network 150 using the network I/F unit 210. When the packet data is input into the network I/F unit 210 (step S31/YES), the network I/F unit 210 restores the input packet data to the segment image data, adds blanking data to the segment image data and outputs the segment image data with the blanking data added to the image generating unit 220. When the image data is input through the network I/F unit 210, the image generating unit 220 generates (synthesizes) combined image data from the plurality of pieces of image data with reference to the combined image conversion pattern data stored in the storage unit 240 (step S33).

As described above, according to the above mentioned embodiment, image data is worked to obtain use ranges and reduction rates recorded as transmit image conversion pattern data and segment image data obtained by working the image data is transmitted to the image processing apparatus 200. Therefore, reduction of the amount of data transferred from the imaging apparatus and generation of combined image of high quality may be attained simultaneously.

The invention is not limited to the above mentioned embodiment and may be embodied in a variety of ways without departing from the gist of the present invention.

All examples and conditional language recited herein are intended for pedagogical purposes to aid the reader in understanding the principles of the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present inventions have been described in detail, it should be understood that the various changes, substitutions, and alterations could be made hereto without departing from the spirit and scope of the invention.

What is claimed is:

1. An image processing system comprising:
a plurality of image capture units mounted on a vehicle; and
an image processing apparatus connected with the plurality of image capture units via a network and configured to generate combined image data from a plurality of pieces of image data taken by the plurality of image capture units and to make a display unit display the combined image data,
each of the plurality of image capture units comprising:
a camera capturing an image data of one of surrounding parts of the vehicle;
a storage unit storing a use part information indicative of a use part of the image data that is used in the combined image data, the use part information being calculated with reference to coordinate conversion data corresponding to a pattern of the combined image data, and an importance degree being calculated per the use part based on a resolution necessary for each use part upon generation of the combined image data;
an image clipping unit clipping a plurality of segment image data serving as the use parts in the combined image data from the image data taken by the camera with reference to the use part information;
a transmit image data generating unit performing image processing according to the importance degree of the use parts on each of the segment image data corresponding to each of the clipped use parts with reference to the importance degree to generate a transmit image data; and
a transmitting unit transmitting the transmit image data to the image processing apparatus, and
the image processing apparatus comprising:
a network interface unit inputting a plurality of pieces of the transmit image data transmitted from the plurality of image capture units;
an image generating unit generating the combined image data based on the plurality of pieces of transmit image data; and
an output unit outputting the combined image data to the display device.

2. The image processing system according to claim 1, wherein the importance degree that each of the storage unit of the image capture units stores are information calculated based on pixel scaling rates used when each pixel of the image data is converted to the combined image data.

3. The image processing system according to claim 2, wherein the pixel scaling rates are information corrected in accordance with a distance from the vehicle to a positions corresponding to each pixel in the combined image data.

4. The image processing system according to claim 1, wherein the use part information and the importance degree that each of the storage unit of the image capture units stores are information generated from coordinate information indicative of a location where the camera is mounted on the vehicle, angle information indicative of an angle at which the camera is installed and characteristic data of a lens provided on the camera.

5. The image processing system according to claim 2, wherein the use part information and the importance degree that each of the storage unit of the image capture units stores are information generated from coordinate information indicative of a location where the camera is mounted on the vehicle, angle information indicative of an angle at which the camera is installed and characteristic data of a lens provided on the camera.

6. The image processing system according to claim 3, wherein the use part information and the importance degree that each of the storage unit of the image capture units stores are information generated from coordinate information indicative of a location where the camera is mounted on the vehicle, angle information indicative of an angle at which the camera is installed and characteristic data of a lens provided on the camera.

7. The image processing system according to claim 1, wherein the transmitting unit further changes the data size of packet data which is generated by dividing the segment image data and is transmitted to the image processing apparatus, in accordance with the data amount of the segment image data corresponding to the use part which has been subjected to image processing by the transmit image data generating unit.

8. The image processing system according to claim 2, wherein the transmitting unit further changes the data size of packet data which is generated by dividing the segment image data and is transmitted to the image processing apparatus, in accordance with the data amount of the segment image data corresponding to the use part which has been subjected to image processing by the transmit image data generating unit.

9. The image processing system according to claim 3, wherein the transmitting unit further changes the data size of packet data which is generated by dividing the segment image data and is transmitted to the image processing apparatus, in accordance with the data amount of the segment image data corresponding to the use part which has been subjected to image processing by the transmit image data generating unit.

10. The image processing system according to claim 4, wherein the transmitting unit further changes the data size of packet data which is generated by dividing the segment image data and is transmitted to the image processing apparatus, in accordance with the data amount of the segment image data corresponding to the use part which has been subjected to image processing by the transmit image data generating unit.

11. The image processing system according to claim 5, wherein the transmitting unit further changes the data size of packet data which is generated by dividing the segment image data and is transmitted to the image processing apparatus, in accordance with the data amount of the segment image data corresponding to the use part which has been subjected to image processing by the transmit image data generating unit.

12. The image processing system according to claim 6, wherein the transmitting unit further changes the data size of packet data which is generated by dividing the segment image data and is transmitted to the image processing apparatus, in accordance with the data amount of the segment image data corresponding to the use part which has been subjected to image processing by the transmit image data generating unit.

13. An image capture unit capturing an image data of surroundings of a vehicle, connected to an image processing apparatus via network in the vehicle to generate a combined image data based on a plurality of image data, the image capture unit comprising:
a camera capturing an image data of one of surrounding parts of the vehicle;
a storage unit storing a use part information indicative of a use part of the image data that is used in the combined image data, the use part information being calculated with reference to coordinate conversion data corresponding to a pattern of the combined image data, and an importance degree being calculated per the use part based on the resolution necessary for each use part upon generation of the combined image data;
an image clipping unit clipping a plurality of segment image data serving as the use parts in the combined image data from the image data taken by the camera with reference to the use part information;
a transmit image data generating unit performing image processing according to the importance degree of the use parts on each of the segment image data corresponding to each of the clipped use parts with reference to the importance degree to generate a transmit image data; and
a transmitting unit transmitting the transmit image data to the image processing apparatus through the network.
